(19) United States
(12) Patent Application Publication
(10) Pub. No.: US 2016/0267399 A1
(43) Pub. Date: Sep. 15, 2016

(54) ANALYSIS DEVICE, ANALYSIS METHOD, PROGRAM, AND RECORDING MEDIUM

(71) Applicant: NIPPON YUSEN KABUSHIKI KAISHA

(72) Inventors: Kazuto KOYAMA, Tokyo (JP); Atsushi YAMAGUCHI, Tokyo (JP)

(73) Assignee: NIPPON YUSEN KABUSHIKI KAISHA, Tokyo (JP)

(21) Appl. No.: 14/898,915

(22) PCT Filed: Jun. 18, 2013
(86) PCT No.: PCT/JP2013/066713

§ 371 Date: Dec. 16, 2015

(51) Int. Cl. G06Q 10/02; G06Q 10/10

(52) U.S. Cl. CPC G06Q 10/02; G06Q 10/1095

(57) ABSTRACT

An analysis device acquires various sorts of information related to a schedule of the voyage such as a ship name, a departure port name, a destination port name, names of ports of call between the departure port and the destination port, scheduled dates of arrival at each port on a sailing route of the voyage, scheduled dates of departure from each port on the sailing route, etc. The analysis device acquires from a first database a table containing dates of events that occur at ports on the sailing route indicated by the acquired information. The analysis device counts a number of days on which the time schedule of the voyage is affected by the events by use of the acquired information related to the schedule and the acquired table, and displays the counted number of days.

### TECHNICAL FIELD

The present invention pertains to a technique of facilitating preparation of a schedule of a voyage by a user.

### BACKGROUND ART

An invention relating to a system of facilitating allocation of a ship to a shipping service, by a user, by use of a simulation of a voyage is disclosed in, for example, JP2002-68418A. According to the system, a departure timing from a port is estimated on the basis of a ship type, type(s) of cargo, quantity of cargo, an arrival timing at the port, etc., and the estimated departure timing is displayed on a screen.

A time schedule of a voyage may be affected by circumstances at ports on its sailing route. For example, when a ship arrives at a port in a country on a date of a holiday in that country, cargo handling operations may not be carried out on the date of arrival. Accordingly, it is preferable to prepare a schedule of a voyage from a departure port to a destination port so that a ship visits each port on a sailing route of the voyage on a date that does not affect a time schedule of the voyage, such as a holiday.

According to the system disclosed in JP2002-68418A, as described in paragraph 0021, a departure timing from a port is calculated based on an arrival timing at the port, a time required for berthing and an estimated time required for cargo handling operations. Namely, the system disclosed in JP2002-68418A takes into account an estimated time required for cargo handling operations at a port when it estimates a departure timing from the port, but it does not take into account any effect of an event occurring during a voyage on a time schedule of the voyage.

### SUMMARY

In view of the foregoing circumstances, the purpose of the present invention is to provide a user with information on how much a time schedule of a voyage is affected by an event that a ship encounters during the voyage

To solve the above-explained problem, in the present invention, there is provided an analysis device comprising a first acquisition unit that acquires a first data set indicating ports that are visited by a ship during a voyage and a second data set indicating a period during which the ship stays at each of the ports, a second acquisition unit that acquires a third data set indicating one or more periods during which one or more events occur at any one of the ports indicated by the first data set, a calculation unit that calculates, if one or more of the periods indicated by the second data set and the one or more periods indicated by the third data set contain one or more periods in common, effect on the one or more periods indicated by the second data set caused by one or more events that occur during the one or more common periods, and an output unit that outputs a data set indicating a result of the calculation carried out by the calculation unit

In a preferred embodiment of the above mentioned analysis device, the first acquisition unit may acquire the first data set with regard to each of the ports that are visited by ships that sail on a certain sailing route, the first acquisition unit may acquire the second data set with regard to each of the ships that sail on the certain sailing route and with regard to each of the ports, and the calculation unit may calculate, with regard to each of the ships, if the one or more of the periods indicated by the second data set and the one or more periods indicated by the third data set contain one or more common periods with regard to one or more common ports indicated by the first data set, effect on the periods indicated by the second data set caused by one or more events that occur during the one or more common periods.

In a preferred embodiment of the above mentioned analysis device, the calculation unit may calculate fuel consumption required for the ship to sail from a departure port to a destination port under a condition that one or more of the periods indicated by the second data set are changed on the basis of the calculated effect, and the output unit may output a data set indicating the fuel consumption calculated by the calculation unit.

In a preferred embodiment of the above mentioned analysis device, the calculation unit may calculate, when a period indicated by the second data set with regard to a first port and a period indicated by the third data set with regard to the first port is common, a time required for the ship to sail from the first port to a second port that is a port visited by the ship subsequent to the first port, the calculation unit may generate, if the ship cannot arrive at the second port on an arrival date indicated by the second data set with regard to the second port when the period indicated by the second data set with regard to the first port is changed based on the calculated effect and the ship sails in the calculated time from the first port to the second port, a data set indicating information on delay of arrival at the second port, and the output unit may output the data set indicating information on delay of arrival.

In addition, in the present invention, there is provided an analysis method comprising a first acquisition step for a device to acquire a first data set indicating ports that are visited by a ship during a voyage and a second data set indicating a period during which the ship stays at each of the ports, a second acquisition step for the device to acquire a third data set indicating one or more periods during which one or more events occur at any one of the ports indicated by the first data set, a calculation step for the device to calculate, if one or more of the periods indicated by the second data set and the one or more periods indicated by the third data set contain one or more common periods, effect on the one or more periods indicated by the second data set caused by one or more events that occur during the one or more periods in common, and an output step for the device to output a data set indicating a result of the calculation carried out in the calculation step.

In the present invention, there is provided a program for causing a computer to function as a first acquisition unit that acquires a first data set indicating ports that are visited by a ship during a voyage and a second data set indicating a period during which the ship stays at each of the ports, a second acquisition unit that acquires a third data set indicating one or more periods during which one or more events occur at any one of the ports indicated by the first data set, a calculation unit that calculates, if one or more of the periods indicated by the second data set and the one or more periods indicated by the third data set contain one or more periods in common, effect on the one or more periods indicated by the second data set caused by one or more events that occur during the one or more common periods, and an output unit that outputs a data set indicating a result of the calculation carried out by the calculation unit.

Furthermore, in the present invention, there is provided a program for causing a computer to function as a first acquisition unit that acquires a first data set indicating ports that are visited by a ship during a voyage and a second data set indicating periods during which the ship stays at the ports, a second acquisition unit that acquires a third data set indicating one or more periods during which one or more events occur at any one of the ports indicated by the first data set, a calculation unit that calculates, with regard to each of the ships, if the periods indicated by the second data set and the one or more periods indicated by the third data set contain one or more common periods, effect on the periods indicated by the second data set when the periods indicated by the second data set are changed so that the periods indicated by the second data set and the one or more periods indicated by the third data set should contain no common period, and an output unit that outputs a data set indicating a result of the calculation carried out by the calculation unit.

Furthermore, in the present invention, there is provided a computer-readable recording medium storing the above mentioned program.

According to the present invention, a user can obtain information on how much a time schedule of a voyage is affected by an event that a ship encounters during the voyage.

### BRIEF EXPLANATION OF THE DRAWINGS

FIG. 1 A drawing illustrating an overall configuration of ship analysis system 1.

FIG. 2 A drawing illustrating data tables contained in first database 300.

FIG. 3 A drawing illustrating data tables contained in second database 400.

FIG. 4 A drawing illustrating a hardware configuration of analysis device 100.

FIG. 5 A drawing illustrating a functional configuration of analysis device 100.

FIG. 6 A flowchart illustrating a flow of procedures carried out by control unit 110.

FIG. 7 A drawing illustrating a sample of a displayed screen image.

FIG. 8 A drawing illustrating a sample of a displayed screen image.

FIG. 9 A drawing illustrating a sample of a displayed screen image.

FIG. 10 A drawing illustrating a sample of a displayed screen image.

### DESCRIPTION OF REFERENCE NUMERALS

1 . . . analysis system, 100 . . . analysis device, 110 . . . control unit, 111 . . . first acquisition unit, 112 . . . second acquisition unit, 114 . . . calculation unit, 116 . . . output unit, 120 . . . storage unit, 130 . . . communication unit, 140 . . . operation unit, 150 . . . display unit, 200 . . . network, 300 . . . first database, 400 . . . second database.

### DETAILED DESCRIPTION

### Exemplary Embodiment

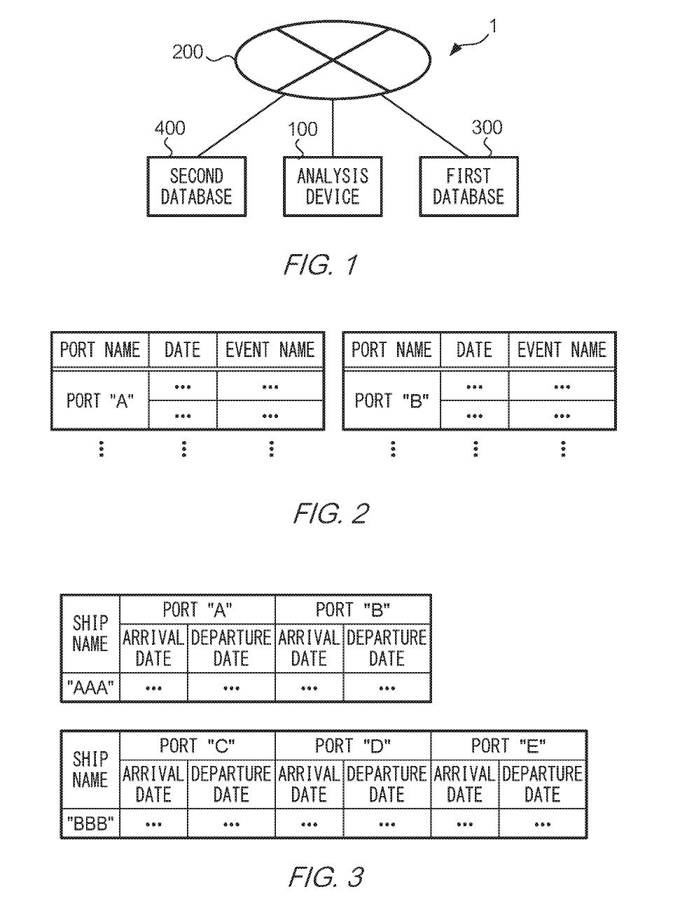

FIG. 1 illustrates an overall configuration of analysis system 1 according to an exemplary embodiment of the present invention. Analysis system 1 acquires information on a schedule of a voyage prepared by a user, and analyzes how much a time schedule of the voyage is affected by an event that is encountered by a ship making the voyage in accordance with the schedule. A result of the analysis output from analysis system 1 facilitates refining of the schedule by the user.

Network 200 is a communication network that provides infrastructure for data communications between devices. Network 200 may be configured as a wired network either with or without one or more wireless parts.

First database 300 is a database storing data sets indicating information on events that occur at ports that are visited by a ship during a voyage. First database 300 contains tables each corresponding to each of the ports visited by the ship as shown in FIG. 2. Each of the tables contains a port name and data records each indicating a correspondence between a date of event that occurs at the port and a name of the event. For example, in the present embodiment, the tables contain dates of public holidays on which various operations at a port are not carried out and names of the public holidays as information on events. Namely, first database 300 according to the present embodiment may store data sets indicating terms during which no operation is carried out at a port because of holidays.

Second database 400 is a database that stores data sets indicating schedules of voyages made by ships. Second database 400 contains tables each corresponding to each of the voyages as shown in FIG. 3. Each of the tables contains a name of a ship, names of ports visited by the ship, a date of arrival at each of the ports, a date of departure from each of the ports, etc.

Analysis device 100 acquires data sets indicating a schedule of a voyage prepared by a user, analyzes effect on a time schedule of the voyage caused by an event that is encountered by a ship during the voyage made in accordance with the schedule, and outputs data sets indicating a result of the analysis. The data sets output from analysis device 100 may indicate, for example, a name of a ship, a number of days on which a time schedule of a voyage is affected by an event when the ship makes a voyage in accordance with the schedule, etc.

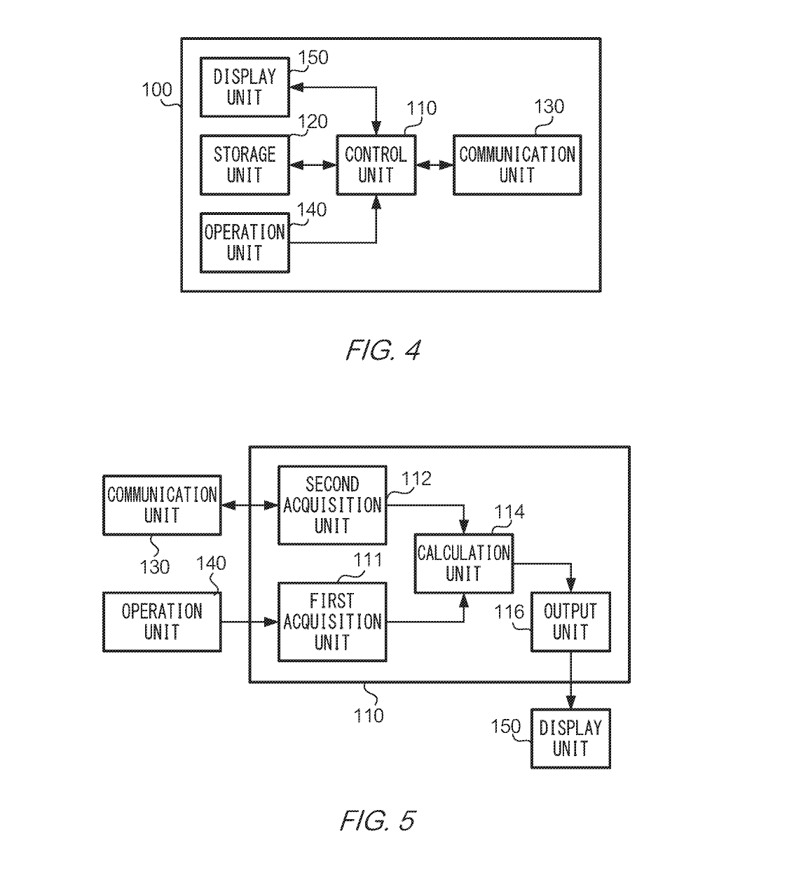

FIG. 4 illustrates a block diagram of hardware configuration of analysis device 100. Analysis device 100 is a computer device that executes programs, and comprises control unit 110, storage unit 120, communication unit 130, operation unit 140 and display unit 150. Analysis device 100 may be any type of computer device such as a personal computer so long as it is capable of executing programs.

Storage unit 120 is a storage device that stores programs and various sorts of data sets. Storage unit 120 comprises, for example, a hard disk, and stores programs executed by control unit 110, data sets used by control unit 110, etc. in the hard disk. Programs stored in storage unit 120 include a program that instructs analysis device 100 to analyze effect on a time schedule of a voyage caused by an event that is encountered by a ship during the voyage, and to output a result of the analysis.

Communication unit 130 is connected to network 200, and it is controlled by control unit 110. Under the control of control unit 110, communication unit 130 communicates with other devices that are connected to network 200. Namely, communication unit 130 transmits data to the other devices and receives data from the other devices via network 200. Communication unit 130 accesses first database 300 to receive data sets from first database 300. Moreover, communication unit 130 accesses second database 400 to transmit data sets to second database 400 and to receive data sets from second database 400.

Operation unit 140 comprises, for example, a mouse and a keyboard operated by a user. A user may operate the mouse and the keyboard to input data sets indicating a schedule of a voyage prepared by the user to analysis device 100. Operation unit 140 may comprise, for example, a touch display instead of a mouse and a keyboard.

Display unit 150 is a display device that displays various sorts of information. Display unit 150 comprises, for example, a liquid crystal display, and displays information indicated by data sets provided from control unit 110 on the liquid crystal display. display unit 150 may be configured as an information output device that outputs information to be displayed to a user to an external display device such as a liquid crystal display and a projector.

Control unit 110 comprises a CPU (Central Processing Unit), a RAM (Random Access Memory), etc., and controls other components of analysis device 100 by executing programs stored in storage unit 120. When control unit 110 executes certain programs stored in storage unit 120, the functions for acquiring a schedule of a voyage prepared by a user, analyzing effect on a time schedule of the voyage caused by an event that is encountered by a ship, and outputting a result of the analysis are realized.

FIG. 5 is a block diagram illustrating a functional configuration realized by control unit 110 when it executes the certain programs. Namely, when control unit 110 executes the certain programs stored in storage unit 120, first acquisition unit 111, second acquisition unit 112, calculation unit 114 and output unit 116 are realized.

First acquisition unit 111 acquires data sets input by a user by use of operation unit 140. A user inputs data sets indicating a schedule of a voyage that the user prepares by use of operation unit 140. First acquisition unit 111 acquires the input data sets from operation unit 140 and outputs the acquired data sets to calculation unit 114. In the present embodiment, it is assumed that a user inputs a name of ship, a name of departure port, a name of destination port, names of ports visited by a ship during the voyage from the departure port to the destination port, an arrival date at each of the ports, a departure date from each of the ports, and other sorts of data sets relating to the voyage as the data sets indicating the schedule of the voyage.

Second acquisition unit 112 acquires data sets stored in first database 300. Second acquisition unit 112 acquires tables such as those shown in FIG. 2 from first database 300.

Calculation unit 114 calculates a number of days on which a schedule of a voyage prepared by a user is affected by an event that is encountered by a ship at a port that is visited by a ship on the basis of data sets acquired by first acquisition unit 111 and second acquisition unit 112.

Output unit 116 outputs a data set indicating a result of calculation carried out by calculation unit 114. Namely, output unit 116 outputs a data set indicating a number of days calculated by calculation unit 114 to display unit 150.

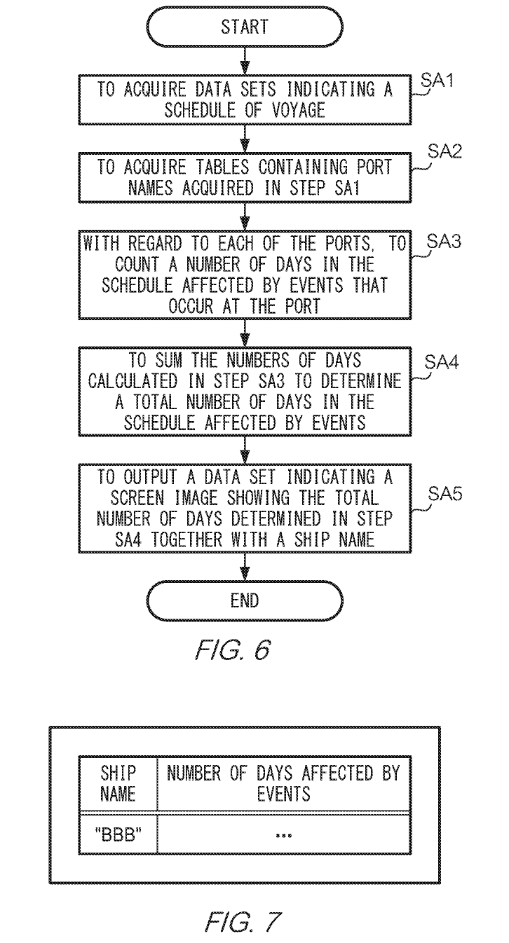

Exemplary operations performed by analysis system 1 are explained below. FIG. 6 is a flowchart showing processes performed by control unit 110 when it executes the programs stored in storage unit 120.

When a user of analysis system 1 wishes to know effect on a time schedule of a voyage caused by events that are encountered by a ship making the voyage following a schedule prepared by the user, he/she operates the keyboard and the mouse of operation unit 140 to input data sets indicating the schedule of the voyage. Namely, the user inputs to analysis device 100, for example, a name of a ship, a name of a departure port, a name of a destination port, names of ports visited by a ship during the voyage from the departure port to the destination port, an arrival date at each of the ports, a departure date from each of the ports, etc. Control unit 110 acquires the data sets input by the user by use of operation unit 140 (step SA1).

For example, it is assumed that a ship whose name is “BBB” departs from departure port “C,” visits port “D” and arrives at destination port “E.” In this case, the user inputs ship name “BBB,” names of the ports, i.e. “C,” “D” and “E,” a date of arrival at each of the ports and a date of departure from each of the ports.

Next, control unit 110 analyzes effect on a time schedule of a voyage indicated by the data sets acquired in step SA1 caused by events that the ship encounters during the voyage when the ship sails following the schedule indicated by the data sets acquired in step SA1. More concretely, control unit 110 acquires tables corresponding to the names of ports acquired in step SA1 from first database 300 (step SA2). For example, in the case where the ship “BBB” departs from departure port “C,” visits port “D,” then arrives at destination port “E” as explained above, control unit 110 acquires a table containing ship name “C,” a table containing ship name “D” and a table containing ship name “E” from first database 300.

Next, control unit 110 compares dates indicated by the data sets acquired in step SA1 and dates indicated by the tables acquired in step SA2, and with regard to each of the ports, control unit 110 counts a number of days on which events occur at the port to affect the schedule of the voyage (step SA3).

For example, when the ship makes a voyage following the above-explained schedule, cargo handling operations for ship “BBB” are performed at port “C.” Control unit 110 specifies dates on which ship “BBB” stays at port “C” on the basis of the data sets acquired in step SA1. If an arrival date at port “C” and a departure date from port “C” are the same date, a number of days on which ship “BBB” stays at port “C” becomes “1.” If the arrival date and the departure date are different, the number becomes “2” or more. Next, control unit 110 refers to the table acquired from first database 300 that contains port name “C” to judge whether each of the specified dates is contained in the table. For example, when the table containing ship name “C” does not contain any of the specified dates, control unit 110 determines that the time schedule of the voyage made by ship “BBB” is not affected by any event that takes place at port “C,” and control unit 110 also determines that a number of days on which the time schedule of the voyage is affected is “0.”

In accordance with the above-mentioned schedule, cargo handling operations are performed for ship “BBB” at port “D.” Accordingly, control unit 110 specifies dates on which the ship stays at port “D” on the basis of the data sets acquired in step SA1. Then, control unit 110 refers to a table acquired from first database 300 that contains port name “D” to judge whether each of the specified dates is contained in the table. For example, if an arrival date at port “D” and a departure date from port “D” is the same date, and the date is contained in the table, cargo handling operations for ship “BBB” at port “D” are not carried out on that date. In this case, control unit 110 judges that the time schedule of the voyage of ship “BBB” is affected by the event occurring at port “D.” Accordingly, control unit 110 postpones the arrival date at port “D” and the departure date from port “D” to the first date on which there is no event by referring to the table containing ship name “D,” and counts a number of days that are postponed as a number of days on which the time schedule is affected.

Next, control unit 110 counts a number of days on which the time schedule is affected during the voyage with regard to destination port “E” in the same way as in the cases of ports “C” and “D.”

After control unit 110 completes counting a number of days on which the time schedule is affected with regard to each of the ports that the ship visits during the voyage, control unit 110 sums the counted numbers of such days to determine a total number of days on which the time schedule is affected (step SA4).

After control unit 110 completes the process of step SA4, it generates a screen image showing the ship name acquired in step SA1 and the number of days determined in step SA4, and outputs a data set indicating the generated screen image to display unit 150 (Step SA5). Display unit 150 acquires the data set from control unit 110, and displays the screen image indicated by the acquired data set. FIG. 7 is an example of a screen image displayed by display unit 150. As illustrated in FIG. 7, display unit 150 displays a number of days on which the time schedule is affected during the voyage.

According to analysis device 100, a number of days on which the time schedule is affected during the voyage is displayed to a user of analysis device 100. Accordingly, the user of analysis device 100 can know whether a ship can make a voyage in accordance with a schedule that he/she prepares. If the schedule that the user prepares is affected by events, the user usually modifies the schedule so that the number of days affected by events is decreased by referring to the information shown in the screen image.

In the present embodiment, a data set indicating a schedule of a voyage input by a user is stored in second database 400 in response to a certain operation performed by the user by use of operation unit 140.

### Modifications

The above-explained embodiment is one exemplary embodiment of the present invention that does not limit a scope of the present invention. Namely, the above-explained embodiment may be implemented in various modified forms within the present invention. In the following part, some examples of such modifications are explained. Two or more of the following modifications may be combined.

In the above-explained embodiment, a ship name and a total number of days in a schedule of a voyage affected by events are displayed in a screen image as shown in FIG. 7. The present invention is not limited with regard to information displayed in a screen image.

For example, control unit 110 may not carry out the process in step SA4 for summing numbers of days on which the time schedule is affected counted with regard to each of ports, and display unit 150 may display a screen image showing numbers of such days with regard to each of the ports as shown in FIG. 8.

In the above-explained embodiment, it is assumed that a ship sails from a departure port to a destination port only once in accordance with a schedule of a voyage. A schedule of a voyage indicated by a data set input to analysis device 100 by a user is not limited with respect to this point. Analysis device 100 may acquire a data set indicating a schedule of a voyage for a regular service in which a ship repeats a return voyage between port A and port B every two weeks for a half year. In this case, control unit 110 specifies, with regard to each return voyage, an arrival date at port “A,” a departure date from port “A,” an arrival date at port “B” and a departure date from port “B.” Control unit 110 acquires a table containing ship name “A” and a table containing ship name “B” from first database 300. Control unit 110 counts, with regard to each port, a number of days on which the time schedule is affected occurring at the port on the basis of the acquired table corresponding to the port and the specified arrival date and departure date with regard to the port. Then, control unit 110 generates a screen image showing each of the counted numbers, and outputs a data set indicating the generated screen image to display unit 150. According to this configuration, a user can know whether a ship can make a voyage for a regular service in accordance with a schedule.

There may be a regular service in which several ships repeat a return voyage from a departure port and return to the departure port after visiting several ports. The present invention may be used for preparing a schedule of such a voyage.

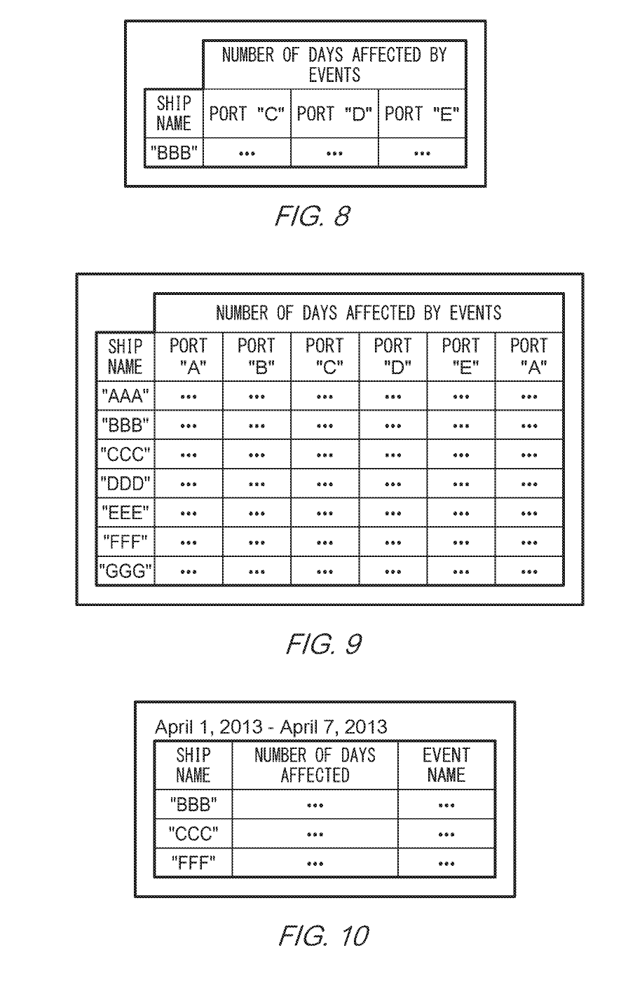

In this case, a user inputs, with regard to each of the ships, with regard to each of the return voyages and with regard to each of the ports on the return sailing route, an arrival date at the port and a departure date from the port. Analysis device 100 may count, with regard to each of the ships, a number of days on which the time schedule is affected by events, and display a screen image showing the counted number of such days with regard to each ship and with regard to each port as shown in FIG. 9. Analysis device 100 may sum, with regard to each ship, numbers of days on which the time schedule is affected counted with regard to the ports on the round sailing route, and display a result of the sum with regard to each ship.

In the above-explained embodiment, each table stored in first database 300 contains data sets indicating information on holidays. The sort of information indicated by data sets contained in first database 300 is not limited to information on holidays, and any sort of information may be indicated by the data sets so long as the information relates to events that affect a time schedule of a voyage because of interrupted operations at a port.

For example, when a port cannot be used because of construction work, when a port cannot be used because of bad weather, etc., cargo handling operations cannot be carried out, as on holidays, and a time schedule of a voyage is affected by these events. Accordingly, each table stored in first database 300 may contain data sets indicating dates on which a port cannot be used because of construction work or bad weather, etc., in addition to holidays. Data sets in tables of first database 300 indicating irregular events such as the above-mentioned construction work at a port and bad weather may be deleted from the tables once these events are no longer relevant.

The sort of information indicated by data sets contained in first database 300 is not limited to information on dates on which a port cannot used. For example, a time schedule of a voyage may be affected by a port congestion. When a port is congested, a ship is obliged to anchor off shore until the ship is allowed to enter the port. Accordingly, tables in first database 300 may contain data sets each indicating a period during which a port congestion is expected and an average number of stand-by days from an arrival time at the port to a timing when the ship is allowed to enter the port.

For example, during a period of Ramadan, a total amount of cargo of imported goods is increased remarkably, and a port becomes congested. As a result, a time schedule of a voyage is affected by Ramadan.

For example, when port “A” is affected by Ramadan, a table as shown in FIG. 2 corresponding to port “A” may contain data sets indicating a period of Ramadan and an average number of stand-by days caused by a port congestion during Ramadan. In this case, analysis device 100 may determine a number of days in a time schedule of a voyage affected by the port congestion based on the period of Ramadan and the average number of stand-by days indicated by the data sets stored in first database 300. For example, when an arrival date at port “A” of the ship is included in the period of Ramadan indicated by the data sets in the table, analysis device 100 judges that the time schedule of the voyage is affected by the event occurring at port “A.” Accordingly, analysis device 100 refers to the table containing ship name “A” and specifies an average number of stand-by days caused by a port congestion as a number of days on which the time schedule is affected.

First database 300 may store data sets indicating further different sorts of information. For example, a time schedule of a voyage may be affected by a dense fog, since a ship is sometimes obliged to anchor off-shore until the dense fog disappears. Accordingly, each table in first database 300 may contain data sets each indicating a period of expected dense fog and an estimate of stand-by days caused by the dense fog.

For example, when port “A” is expected to be affected by a dense fog, a table as shown in FIG. 2 corresponding to port “A” may contain data sets indicating a period of the expected dense fog and an estimated number of stand-by days caused by the dense fog. When an arrival date at port “A” of the ship is included in the period of the expected dense fog indicated by the data sets in the table, analysis device 100 judges that the time schedule of the voyage is affected by the event occurring at port “A.” Accordingly, analysis device 100 refers to the table containing ship name “A” and specifies the number of stand-by days caused by the dense fog as a number of days on which the time schedule is affected.

Usually, it is difficult to estimate a precise number of stand-by days caused by a port congestion or a dense fog. Accordingly, tables of first database 300 may contain data sets indicating ranges of numbers of stand-by days instead of numbers of stand-by days. For example, when an estimated range of number of stand-by days at port “A” is from 1 day to 3 days, a table as shown in FIG. 2 corresponding to port “A” may contain data sets indicating a range from 1 day to 3 days in association with a period of the expected port congestion or dense fog. When an arrival date at port “A” of the ship is included in the period of, for example, the expected dense fog indicated by the data sets in the table, analysis device 100 determines that a number of days in the time schedule of the voyage affected by the event is in the range from 1 day to 3 days.

In the present invention, data sets may be added to a table of first database 300 or data sets may be deleted from a table of first database 300 after a ship starts a voyage as in some of the above-explained modifications. When data sets are added to a table of first database 300 or data sets are deleted from a table of first database 300 after a ship starts a voyage, analysis device 100 may acquire data sets indicating a schedule of a voyage from second database 400, and count a number of days on which the time schedule is affected by events during the period of voyage according to the schedule indicated by the acquired data sets. According to this configuration, a user can know a number of days on which the time schedule is affected by events that were not recognized when the schedule was prepared, or a number of days on which the time schedule is affected by events, excluding events that were expected to occur during the voyage but then canceled.

In the present invention, analysis device 100 may display a number of days on which the time schedule is affected in a certain period such as a certain day, week or month that is designated by a user with regard to a schedule of a voyage indicated by data sets stored in second database 400. FIG. 10 is an example of a screen image displayed in this modification. For example, when a user performs operations to input a certain period (for example, a certain week) to analysis device 100 and to instruct analysis device 100 to display a number of days on which the time schedule is affected during the certain period, analysis device 100 displays a screen image showing a number of days on which the time schedule is affected by events during the certain period with regard to each ship as shown in FIG. 10.

In the above-explained embodiment, all of an acquisition of data sets indicating a schedule of a voyage prepared by a user, an analysis of effect of events on a time schedule of the voyage and a display of a result of the analysis are performed by analysis device 100. The present invention is not limited to this configuration. For example, analysis device 100 may be configured as a server device, a user may input data sets indicating a schedule of a voyage by use of a terminal device that functions as a client device of the server device, and the terminal device may transmit the data sets input by the user to analysis device 100. In this modification, analysis device 100 may transmit a result of analysis to the terminal device in response to the data sets indicating the schedule, and the terminal device may display a screen image showing the result of analysis performed by analysis device 100.

In the above-explained embodiment, analysis device 100 displays a number of days on which the time schedule is affected by events during a schedule of a voyage with regard to a single voyage. Analysis device 100 may display a number of days in a schedule of a voyage affected by events with regard to each of plural time schedules of a voyage on a certain sailing route. For example, when a ship sails from departure port “C,” visits port “D” on the way and sails to destination port “E” as in the case of the above-explained embodiment, a user may input plural time schedules whose arrival dates at the ports and departure dates from the ports are different from one another, and analysis device 100 may display a number of days in each time schedule affected by events. According to this configuration, a user can compare numbers of days on which the time schedule is affected by events with regard to different plural time schedules and select one of them to prepare a desirable schedule of a voyage.

In the above-explained embodiment, it is assumed that a user inputs timings of arrivals of a ship at ports and departures of the ship from ports by units of days. These timings may be input using any other time unit such as units of minutes. Namely, data sets indicating a time schedule of a voyage used by analysis device 100 may contain timings of arrivals and departures expressed in units of minutes.

In the above-explained embodiment, each of first database 300 and second database 400 is stored in a separate device from analysis device 100, and analysis device 100 accesses first database 300 and second database 400 via network 200. The present invention is not limited to this configuration. For example, storage unit 120 may store first database 300 and second database 400, and control unit 110 may access each of the databases stored in storage unit 120.

In the above-explained embodiment, analysis device 100 displays a number of days on which the time schedule is affected during a voyage. Analysis device 100 may display any sorts of information other than the number of such days. For example, analysis device 100 acquires data sets indicating distances between neighboring ports on a sailing route, and calculates a sailing speed from a port to a next port by use of the distances indicated by the acquired data sets and a time schedule of a voyage, i.e. an arrival date at each port and a departure date from each port. Analysis device 100 calculates fuel consumption required for a voyage in accordance with the time schedule based on a relationship between sailing speeds and fuel consumption rates such as fuel consumption per day and the calculated sailing speeds. Then, analysis device 100 displays the calculated fuel consumption. Analysis device 100 may calculate fuel consumption for each of plural different time schedules, and display the calculated fuel consumption for selection by a user. According to this configuration, a user can know total fuel consumption required for a voyage when each of the time schedules is used. Accordingly, the user can prepare a schedule of a voyage following a time schedule that requires, for example, the least fuel consumption by referring to the information displayed by analysis device 100. In this modification, analysis device 100 may calculate fuel consumption required for sailing each of plural sections comprising a sailing route instead of or in addition to total fuel consumption required for sailing the entire sailing route. Moreover, in this modification, analysis device 100 may calculate a sum of fuel consumption required for sailing performed by each of plural ships that provide a certain shipping service on a certain sailing route. Moreover, in this modification, analysis device 100 may select a time schedule that requires the least fuel consumption from among the plural time schedules, and display the selected time schedule.

Analysis device 100 may display information on delays in a time schedule of a voyage in addition to a number of days on which the time schedule is affected by events and fuel consumption required for sailing in accordance with the time schedule. For example, when a time schedule of a voyage is affected by an event that occurs at a certain port, analysis device 100 shifts the arrival date of a ship at the certain port to the first date after the original arrival date that is not affected by the event, and specifies a new departure date from the port based on the new arrival date at the port. Analysis device 100 acquires distances between neighboring ports and a sailing speed of the ship such as the maximum sailing speed. Analysis device 100 calculates a time required for the ship to sail to the next port based on the specified new departure date, a distance from the current port to the next port and the acquired sailing speed. Analysis device 100 calculates a new arrival date at the next port based on the calculated time, and displays a difference between the original arrival date at the next port input by the user and the new arrival date at the next port calculated by analysis device 100 as information on delay in the time schedule. In this modification, analysis device 100 may acquire any types of sailing speed of the ship other than the maximum sailing speed.

In the above-explained embodiment, analysis device 100 calculates a number of days that are required to be shifted to other days because of events.

Alternatively, when a user inputs data sets indicating a schedule of a voyage, he/she may input data sets indicating ports that may be omitted from among ports on a sailing route of the voyage, and when the schedule is affected by an event at a port that may be omitted, analysis device 100 may notify the user that the port is not visited by the ship on the sailing route. For example, when a schedule of a voyage performed by ship “BBB” is affected by an event at port “D,” analysis device 100 displays a number of days affected by the event in the above-explained embodiment. In this modification, analysis device 100 receives data sets indicating ports that may be omitted, and when port “D” is included in the ports that may be omitted, analysis device 100 notifies the user that the ship does not visit port “D.”

Moreover, when a user inputs data sets indicating a schedule of a voyage, he/she may input data sets indicating alternative ports that may be visited instead of the port that may be omitted from among ports on a sailing route of the voyage, arrival dates at the alternative ports and departure dates from the alternative ports. For example, when port “F” may be visited instead of port “D” in the sailing route of a voyage performed by ship “BBB,” a user inputs data sets indicating that port “F” can be substituted for port “D” and data sets indicating an arrival date at port “F” and a departure date from port “F.” When the schedule is affected by an event at port “D,” analysis device 100 notifies the user that the ship should visit port “F” instead of port “D.”

A program that realizes a function according to the present invention may be provided in a form being stored in a computer-readable recording medium such as a magnetic recording medium, i.e. a magnetic tape, a magnetic disk such as HDD (Hard Disk Drive) and FD (Flexible Disk), etc., an optical recording medium such as a laser disk, a magneto-optical recording medium, a semiconductor memory, etc., and read from the recording medium to be installed in analysis device 100. Alternatively, the program may be downloaded from a server to analysis device 100 via network 200 and installed in analysis device 100.

What is claimed is:

1-7. (canceled)

8. An analysis device comprising:
a first acquisition unit that acquires a first data set indicating ports that are visited by a ship during a voyage and a second data set indicating a period during which the ship stays at each of the ports;
a second acquisition unit that acquires a third data set indicating one or more periods during which one or more events occur at any one of the ports indicated by the first data set;
a calculation unit that calculates, if one or more of the periods indicated by the second data set and the one or more periods indicated by the third data set contain one or more periods in common, effect on the one or more periods indicated by the second data set caused by one or more events that occur during the one or more common periods; and
an output unit that outputs a data set indicating a result of the calculation carried out by the calculation unit.

9. The analysis device according to claim 8, wherein:
the first acquisition unit acquires the first data set with regard to each of the ports that are visited by ships that sail on a certain sailing route;
the first acquisition unit acquires the second data set with regard to each of the ships that sail on the certain sailing route and with regard to each of the ports; and
the calculation unit calculates, with regard to each of the ships, if the one or more of the periods indicated by the second data set and the one or more periods indicated by the third data set contain one or more common periods with regard to one or more common ports indicated by the first data set, effect on the periods indicated by the second data set caused by one or more events that occur during the one or more common periods.

10. The analysis device according to claim 8, wherein:
the calculation unit calculates fuel consumption required for the ship to sail from a departure port to a destination port under a condition that one or more of the periods indicated by the second data set are changed on the basis of the calculated effect; and
the output unit outputs a data set indicating the fuel consumption calculated by the calculation unit.

11. The analysis device according to claim 10, wherein:
the calculation unit calculates, when a period indicated by the second data set with regard to a first port and a period indicated by the third data set with regard to the first port is common, a time required for the ship to sail from the first port to a second port that is a port visited by the ship subsequent to the first port;
the calculation unit generates, if the ship cannot arrive at the second port on an arrival date indicated by the second data set with regard to the second port when the period indicated by the second data set with regard to the first port is changed based on the calculated effect and the ship sails in the calculated time from the first port to the second port, a data set indicating information on delay of arrival at the second port; and
the output unit outputs the data set indicating information on delay of arrival.

12. An analysis method comprising:
a first acquisition step for a device to acquire a first data set indicating ports that are visited by a ship during a voyage and a second data set indicating a period during which the ship stays at each of the ports;
a second acquisition step for the device to acquire a third data set indicating one or more periods during which one or more events occur at any one of the ports indicated by the first data set;
a calculation step for the device to calculate, if one or more of the periods indicated by the second data set and the one or more periods indicated by the third data set contain one or more common periods, effect on the one or more periods indicated by the second data set caused by one or more events that occur during the one or more periods in common; and
an output step for the device to output a data set indicating a result of the calculation carried out in the calculation step.

13. A program stored on a non-transitory computer readable medium, the program for causing a computer to function as:
a first acquisition unit that acquires a first data set indicating ports that are visited by a ship during a voyage and a second data set indicating a period during which the ship stays at each of the ports;
a second acquisition unit that acquires a third data set indicating one or more periods during which one or more events occur at any one of the ports indicated by the first data set;
a calculation unit that calculates, if one or more of the periods indicated by the second data set and the one or more periods indicated by the third data set contain one or more periods in common, effect on the one or more periods indicated by the second data set caused by one or more events that occur during the one or more common periods; and
an output unit that outputs a data set indicating a result of the calculation carried out by the calculation unit.

14. A computer-readable recording medium storing the program according to claim 13.
